(19) United States
(12) Patent Application Publication
(10) Pub. No.: US 2006/0035079 A1
(43) Pub. Date: Feb. 16, 2006

(54) Stress-luminescent composition containing anisotropic stress-luminescent material, and method of producing the same

(75) Inventors: Chao-Nan Xu, Saga (JP); Yusuke Imai, Saga (JP); Yoshio Adachi, Saga (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NATIONAL INSTITUTE OF ADVANCED INDUSTRIAL SCIENCE AND TECHNOLOGY, Tokyo (JP)

(21) Appl. No.: 11/188,134

(22) Filed: Jul. 25, 2005

(30) Foreign Application Priority Data
Jul. 26, 2004 (JP) 2004-217716

(51) Int. Cl. C09K 11/08; B32B 5/16

(52) U.S. Cl. 428/402; 428/323; 428/328; 428/331; 428/690; 428/364; 252/301.36; 252/301.4 R

(57) ABSTRACT

A stress-luminescent material emits luminescence when external mechanical energy is applied thereto. The fine particles of the material have an anisotropic aspect ratio, preferably, from 2 to 1000, more preferably, from 5 to 100. Raw materials are mixed together in an aqueous solvent, and aqueous ammonia is added thereto to change the pH value, thereby controlling the aspect ratio of the stress-luminescent material particles. Also provided are compositions containing the stress-luminescent material, such as a coating material, an ink, and an adhesive.

### BACKGROUND OF THE INVENTION

1. Field of the Invention

The present invention relates to a stress-luminescent composition containing a stress-luminescent material that emits luminescence in proportion to the magnitude of mechanical energy change, and also pertains to a method of producing the same. More particularly, the present invention relates to a stress-luminescent composition containing an anisotropic stress-luminescent material, and also pertains to a method of producing the same.

2. Discussion of Related Art

Certain substances emit luminescence in response to external stimulation. This is a phenomenon well known as fluorescence. Fluorescent substances that emit fluorescent light are widely used in various fields, including lightings, displays, etc. Examples of external stimulation are ultraviolet rays, electron beams, X-rays, radioactive rays, electric fields, and chemical reactions.

In recent years, stress-luminescent materials that emit luminescence under application of a mechanical external force have been developed by the present inventors [see Japanese Patent Application Unexamined Publication (KOKAI) Nos. 2000-119647, 2000-313878, 2001-049251, 2002-194349, 2003-292949 and 2004-043656].

JP 2000-119647 describes stress-luminescent materials having a spinel structure, a corundum structure, or a β alumina structure.

JP 2000-313878 describes stress-luminescent materials consisting essentially of a silicate.

JP 2001-049251 describes high-intensity stress-luminescent materials consisting essentially of a defect-controlled type aluminate.

JP 2002-194349 describes multicolor stress-luminescent materials.

JP 2003-292949 evaluates stress-luminescent properties by applying mechanical action, e.g. compression, tension, friction, or torsion, to test pieces prepared by using a composite material consisting essentially of a stress-luminescent material and an epoxy resin and a coating film of the composite material.

JP 2004-043656 describes high-intensity mechanoluminescence materials consisting essentially of an oxide, a sulfide, a selenide or a telluride having a structure in which a wurtzite structure and a zincblende structure coexist.

These stress-luminescent materials can emit luminescence repeatedly and semipermanently with a sufficiently high luminous intensity for the luminescence to be recognized with the naked eye. It is desirable to use the stress-luminescent materials for measurement of stress distribution in structures [see Japanese Patent Application Unexamined Publication (KOKAI) Nos. 2001-215157 and 2004-077396]. JP 2001-215157 describes a stress or stress distribution measuring method and measuring system using a stress-luminescent material. JP 2004-077396 describes a light-emitting head capable of transmitting a mechanical external force by converting it directly into a light signal, and also describes a remote switch system using the light-emitting head.

In addition, Japanese Patent Application Unexamined Publication (KOKAI) Nos. 2003-253261 and 2004-071511 propose combining europium-added strontium aluminate, which exhibits stress-luminescent properties, with a polymethacrylate, ABS resin, polycarbonate, polystyrene, polyethylene, polyacetal, urethane resin, polyester, epoxy resin, silicone rubber, or silicone compound having siloxane bond, and an organic piezoelectric material. Japanese Patent Application Unexamined Publication (KOKAI) No. 2004-149738 describes preparation of a transparent stress-luminescent material.

The above-described patent documents mention the size of stress-luminescent particles but make no mention of the shape of them, except for a spherical or near-spherical shape.

### SUMMARY OF THE INVENTION

With the above-described technical background, the present invention was made to attain the following object.

An object of the present invention is to provide a stress-luminescent material having a particle shape capable of emitting high-intensity fluorescence, and also provide a composition and structure that contain the stress-luminescent material, and a method of producing the same.

A first aspect of the present invention provides a stress-luminescent material that emits luminescence when external mechanical energy is applied thereto. The stress-luminescent material consists essentially of stress-luminescent fine particles having an anisotropic aspect ratio.

A second aspect of the present invention provides a bonding agent containing the above-described stress-luminescent material. Preferably, the bonding agent is an adhesive selected from the group consisting of a thermosetting resin adhesive, a thermoplastic resin adhesive, and a rubber adhesive (elastomer), or a composite adhesive consisting of two or more of them. Preferably, the bonding agent further contains microstructures having a higher modulus of elasticity than that of the bonding agent.

A third aspect of the present invention provides a stress-luminescent composition that emits luminescence when external mechanical energy is applied thereto. The stress-luminescent composition contains a stress-luminescent material consisting essentially of stress-luminescent fine particles having an anisotropic aspect ratio. Preferably, the stress-luminescent composition contains the above-described bonding agent. Preferably, the stress-luminescent composition further contains microstructures having a higher modulus of elasticity than that of the bonding agent.

Preferably, the stress-luminescent composition according to the third aspect of the present invention contains at least one additive selected from the group consisting of a coating material, an ink, a fire retardant, a heat stabilizer, an antioxidant, an anti-ultraviolet agent, a plasticizer, a crystal nucleus agent, a blowing agent, an anti-fungus agent, a filler, a reinforcing agent, an electrically conducting filler, and an antistatic additive.

A fourth aspect of the present invention provides a coating material containing the above-described stress-luminescent material. Constituents of the coating material other than the stress-luminescent material, i.e. a resin, a pigment, and an additive, are well-known constituent materials used in the field of coating materials. Therefore, a description thereof is omitted.

A fifth aspect of the present invention provides an ink containing the above-described stress-luminescent material. Constituents of the ink other than the stress-luminescent material, i.e. a solvent and a dye, are those well-known in the technical field of ink. Therefore, a description thereof is omitted.

A sixth aspect of the present invention provides a stress-luminescent sheet consisting essentially of a sheet-shaped material impregnated at the surface or inside thereof with the above-described stress-luminescent composition.

A seventh aspect of the present invention provides a method of producing a stress-luminescent material that emits luminescence when external mechanical energy is applied thereto. The stress-luminescent material consists essentially of an inorganic base material doped with at least one rare earth or transition metal that emits luminescence when their electrons excited by the mechanical energy return to their ground state, as a luminescent center. The fine particles of the stress-luminescent material have an anisotropic aspect ratio. The term “sheet” as used in the present invention means a thin sheet-shaped member that may be paper using natural fiber, synthetic paper, woven or unwoven fabric made of natural or synthetic fiber, or a sheet or film of any of various synthetic resins.

The stress-luminescent material producing method according to the seventh aspect of the present invention is carried out by mixing together an acid salt of the above-described rare earth or transition metal and a raw material of the inorganic base material in a solvent while adding aqueous ammonia thereto so that a predetermined pH value is obtained, thereby forming a sol-gel solution, and adding and mixing a dispersing and emulsifying agent into the sol-gel solution and drying the resulting mixture, followed by heat-treating. The above-described aspect ratio is controlled by changing the pH value.

Preferably, the stress-luminescent material according to the first to seventh aspects of the present invention has at least one external shape selected from the group consisting of an angular shape, a plate shape, an acicular shape, and a rod shape. Preferably, the rod-shaped or acicular particles have an aspect ratio of from 2 to 1000. More preferably, the rod-shaped or acicular particles have an aspect ratio of from 5 to 100. It is also preferable that the fine particles of the stress-luminescent material change the luminous intensity in proportion to the change in magnitude of energy applied thereto.

Preferably, the stress-luminescent material consists essentially of an inorganic base material doped with at least one rare earth or transition metal that emits luminescence when their electrons excited by the mechanical energy return to their ground state, as a luminescent center. More preferably, the stress-luminescent material is an aluminate or a silicate.

Preferably, the fine particles of the stress-luminescent material in the third to fifth aspects of the present invention are uniformly dispersed in the compositions. Further, the microstructures in the second and third aspects of the present invention are preferably fine particles of at least one material selected from the group consisting of metals, glass, ceramics, plastics, synthetic fiber, and natural fiber. More preferably, the microstructures in the second and third aspects of the present invention are fine particles having a shape selected from the group consisting of fibrous, acicular and spherical shapes. Preferably, the bonding agent according to the second and third aspects of the present invention is transparent and flexible.

Preferably, the bonding agent according to the second and third aspects of the present invention is an adhesive selected from the group consisting of a thermosetting resin adhesive, a thermoplastic resin adhesive, and a rubber adhesive (elastomer), or a composite adhesive consisting of two or more of them. Preferably, the composite adhesive is one that is formed by adding a thermoplastic resin or an elastomer to a thermosetting resin, or adding a thermosetting resin to a thermoplastic resin or an elastomer.

[Thermosetting Resin Adhesive]

Preferable thermosetting resin adhesives are formaldehyde resins, e.g. phenol, resorcinol, urea, ethylene urea, melamine, benzoguanamine, furan and xylene resins, epoxy resins, unsaturated polyester resins, polyurethane resins, silicone resins, polydiallyl phthalate resins, or co-condensation polymers of these resins.

[Thermoplastic Resin Adhesive]

Preferable thermoplastics resin adhesives are polymer adhesives having a glass transition point not lower than room temperature, e.g. polyvinyl acetate, polymethyl methacrylate, polystyrene, polyvinyl alcohol, polyvinyl butyral, methylcyano acrylate, polysulfone, polyimide, polybenzimidazole, nylon, polyparaphenyl oxide, polycarbonate, polyacetal, polyethylene, polypropylene, ethylene-vinyl acetate copolymer, and plastic polymers copolymerized with butadiene (ABS resin, and high-impact polystyrene).

[Rubber Adhesive (Elastomer)]

Preferable rubber adhesives (elastomers) are elastic materials having a glass transition temperature not higher than room temperature, e.g. natural rubber, styrene-butadiene rubber, acrylonitrile-butadiene rubber, polychloroprene, polybutadiene, polyisobutylene, polyisoprene-isobutylene, thiokol rubber, and polyacrylate.

[Composite Adhesive]

Preferable composite adhesives are urea-polyvinyl acetate, urea-polyvinyl alcohol, phenolic resin-polyvinyl acetate, phenolic resin-polyvinyl formal, phenolic resin-polyvinyl butyral, phenolic resin-nitrile rubber, phenolic resin-chloroprene rubber, phenolic resin-nylon, melamine resin-acrylic resin, melamine resin-polyvinyl acetate, melamine resin-alkyd resin, epoxy resin-nylon, epoxy resin-polyamide, epoxy resin-acrylic resin, epoxy resin-synthetic rubber, epoxy resin-polysulfide, epoxy resin-polyisocyanate, epoxy resin-xylene resin, and epoxy resin phenolic resin.

The coating material according to the fourth aspect of the present invention preferably has a composition consisting essentially of a resin as a dispersion medium, a pigment as a dispersed phase, an additive, and a solvent. Preferably, the solvent is an organic solvent. Preferably, the coating material is a high-solid coating material with a reduced organic solvent content, a water-based coating material using water as a solvent, or a solvent-free powder coating material.

[Inorganic Base Material]

The above-described inorganic base material may be an oxide, a sulfide, a carbide or a nitride having a stuffed tridymite structure, lattice defect-controlled structures, a wurtzite structure, a spinel structure, a corundum structure, or a b alumina structure, etc.

[Stress-Luminescent Material]

A preferable stress-luminescent material is prepared by doping a base material as mentioned below with a luminescent center formed by at least one rare earth or transition metal that emits luminescence when their electrons excited by mechanical energy return to their ground state.

The stress-luminescent material is prepared by using a composite metal oxide containing strontium and aluminum as a base material and doping it with a rare earth metal or a transition metal as a luminescent center. Examples of such a composite metal oxide are xSrO.yAl₂O₃.zMO (M is a divalent metal such as Mg, Ca, or Ba; x, y and z are integers), and xSrO.yAl₂O₃.zSiO₂ (x, y and z are integers). SrMgAl₁₀O₁₇:Eu, (SrₓBa₁₋ₓ)Al₂O₄:Eu (0<x<1), SrAl₂SiO₇:Eu, etc. are desirable materials. A particularly preferable stress-luminescent material is a ceramic powder material consisting essentially of a defect-controlled type europium-activated strontium aluminate (SrAl₂O₄:Eu).

The present invention offers the following advantageous effects.

The present invention provides a stress-luminescent material whose particles have a predetermined aspect ratio and a method of producing the stress-luminescent material. The stress-luminescent material can emit luminescence in response to an externally applied stress more efficiently than stress-luminescent particles having a spherical or near-spherical shape.

A bonding agent containing the stress-luminescent material further contains microstructures having a higher modulus of elasticity than that of the bonding agent itself. Therefore, an externally applied stress concentrates on the stress-luminescent material between the microstructures, thereby allowing the stress-luminescent material to emit luminescence efficiently. A structural member having such a bonding agent can emit luminescence by efficiently converting externally applied mechanical energy into light as stress-stimulated luminescence.

A coating material containing the stress-luminescent material is used by being applied to a structural member, whereby the stress-luminescent material in a portion of the structural member that is elastically or plastically deformed can emit luminescence. A portion of the structural member where elastic or plastic deformation occurs concentratedly can emit luminescence more strongly than the other portions. In a case where the structural member is in a sheet form, e.g. paper, in particular, a folded edge of the structural member emits luminescence more strongly than the other portions.

### BRIEF DESCRIPTION OF THE DRAWINGS

The above and other objects, features and advantages of the present invention will become more apparent from the following description of the preferred embodiments thereof, taken in conjunction with the accompanying drawings.

FIG. 1 is an electron micrograph of stress-luminescent particles having an anisotropic external shape in Example 1 (aspect ratio of not less than 2).

FIG. 2 is an electron micrograph of stress-luminescent particles having an anisotropic external shape in Example 1 (aspect ratio of not more than 1.5).

FIG. 3 is an electron micrograph of stress-luminescent particles having an anisotropic external shape in Example 1 (aspect ratio of not less than 5).

FIG. 4 is a diagram illustrating the outline of a test piece in Example 2.

FIG. 5 is a diagram illustrating the outline of a joint portion of the test piece in Example 2.

FIG. 6 is a photograph showing the emission of luminescence from the test piece in Example 2.

FIG. 7 is a diagram illustrating the outline of a test piece in a second embodiment of the present invention.

FIG. 8 is a diagram illustrating the outline of a measuring apparatus in the second embodiment.

FIG. 9 is a photograph showing the emission of luminescence from a test piece in Example 3.

FIG. 10 is a graph showing the luminous intensity distribution of visible light emitted from the test piece in Example 3 and a stress distribution obtained by the finite element method.

FIG. 11 is a photograph showing the emission of luminescence from the test piece in Example 3 when pulled slowly by a stress applying device.

FIG. 12 is a conceptual view of a sheet-shaped stress-luminescent structure in a third embodiment of the present invention.

FIG. 13 is a photograph showing the emission of luminescence from a sheet-shaped stress-luminescent structure in Example 4 when the surface thereof was touched in the shape of the letter A.

FIG. 14 is a photograph showing the emission of luminescence from the sheet-shaped stress-luminescent structure in Example 4 when the surface thereof was touched in the shape of the letter O.

### DESCRIPTION OF THE PREFERRED EMBODIMENTS

### First Embodiment

A first embodiment of the present invention will be outlined below. A stress-luminescent material emits luminescence when an external mechanical stress is applied thereto. Particles of the stress-luminescent material or a composite material containing the stress-luminescent particles are usable in various ways. For example, they can be used by mixing in bonding agents or coating materials.

The stress-luminescent particles according to the present invention have an anisotropic external shape whose maximum and minimum diameters are different from each other. The stress-luminescent particles have a characteristic feature that they enable stress concentration to occur more easily than in the case of conventional stress-luminescent particles having a spherical or near-spherical shape, e.g. spherical or spheroidal particles, and hence can give stronger luminescence than the conventional stress-luminescent materials for the same external excitation force. Among anisotropic particles, angular particles, plate-shaped particles, and acicular particles are preferable. Particularly preferable anisotropic particles are rod-shaped or acicular particles having an aspect ratio of from 2 to 1000, more preferably, from 5 to 100 (see Example 1).

The inventors of the present invention examined conditions for forming stress-luminescent material and found that stress-luminescent materials having various particle shapes can be produced by changing the stress-luminescent material forming conditions. As a result, it has become possible to control the particle shape of stress-luminescent materials. Meanwhile, if a homogeneous bonding agent containing fine particles of a stress-luminescent material is allowed to coexist with microstructures having a higher modulus of elasticity than that of the bonding agent, stress concentration occurs in the bonding agent existing between the microstructures. As a result, an increased stress acts on the fine particles of the stress-luminescent material contained in the bonding agent, thereby enabling strong luminescence to be emitted.

The stress-luminescent material can be used by mixing in a variety of adhesives. Examples of usable adhesives are a thermosetting resin adhesive, a thermoplastic resin adhesive, a rubber adhesive (elastomer), and a composite adhesive. A preferable composite adhesive is one that is formed by adding a thermoplastic resin or an elastomer to a thermosetting resin, or adding a thermosetting resin to a thermoplastic resin or an elastomer. An example of an epoxy adhesive (see Example 2) will be described below as an example of adhesive containing the stress-luminescent material.

### EXAMPLE 1

### Anisotropic Stress-Luminescent Particles

Example 1 of the present invention will be shown below.

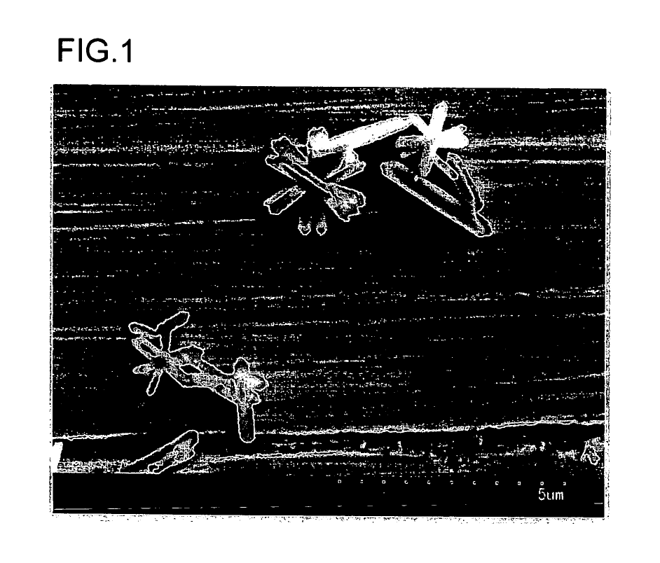

FIG. 1 shows an electron micrograph of formed stress-luminescent particles having an anisotropic external shape. The stress-luminescent particles shown in the micrograph have an aspect ratio of not less than 2. The length in the longer direction of the particles is about 2 □m. The length in the shorter direction of the particles is about 0.3 □m.

### Production Method

Raw materials used were tri-isopropoxy aluminum of a purity of not less than 99%, nitrate of strontium, nitrate of europium, and boric acid. These raw materials were weighed in the ratio of Sr_{0.9}Al₂O₄:Eu_{0.01}, and mixed together in an aqueous solvent while aqueous ammonia was being added thereto so that the pH value was adjusted to 6.0, thereby forming a sol-gel solution. Dimethylformamide was added and mixed into the sol-gel solution as a dispersing and emulsifying agent, and the mixture was dried at 100-200° C. Thereafter, the dried mixture was heat-treated in air at 700° C. The product thus obtained was finely divided and then burned in a reducing atmosphere at 1300° C. for 6 hours, thereby obtaining stress-luminescent material particles.

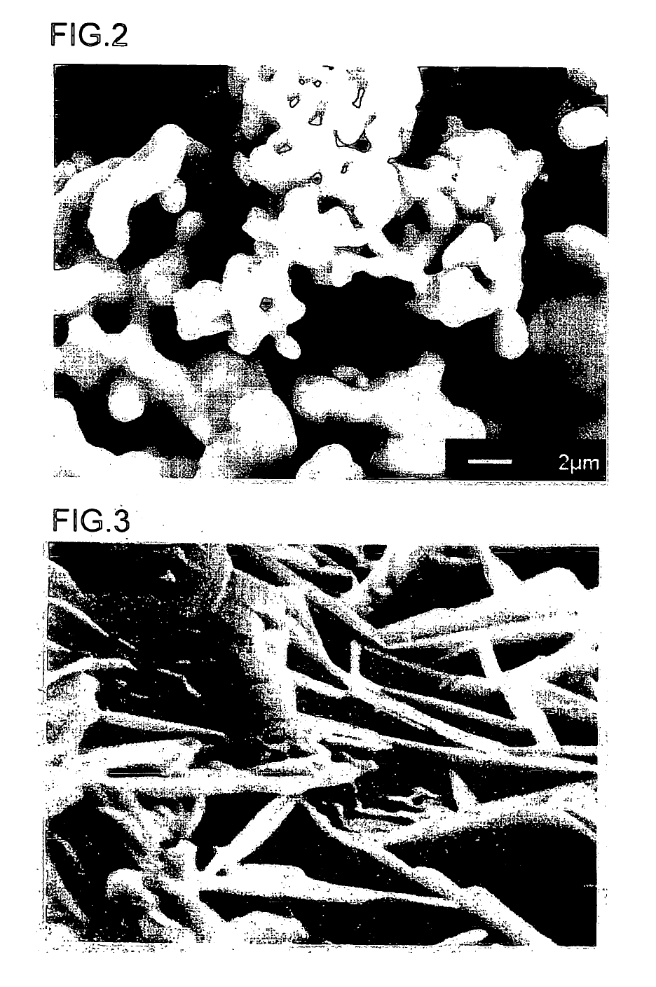

The crystal structure of the obtained stress-luminescent material particles was subjected to identification by X-ray diffraction. As a result, the crystal structure was identified as α-SrAl₂O₄ pure phase. The aspect ratio can be adjusted by changing the pH value. For example, FIG. 2 shows an electron micrograph of stress-luminescent particles obtained by adjusting the pH value to 8. The stress-luminescent material particles shown in the electron micrograph are near-spherical particles having an aspect ratio of not more than 1.5. FIG. 3 shows stress-luminescent material particles obtained when the pH value was adjusted to 11. The particles shown in FIG. 3 are plate-shaped particles having an aspect ratio of not less than 5.

### EXAMPLE 2

Next, an adhesive containing anisotropic stress-luminescent particles will be explained. The stress-luminescent adhesive consists essentially of an epoxy adhesive (A), stress-luminescent particles (B), and stress-increasing structures (C). The epoxy adhesive (A) was transparent and prepared as follows. Bisphenol-A.epichlorohydrin (average molecular weight<700), which is a reactive epoxy resin manufactured by Struers, on the one hand, and isopropyl diamine as a curing agent and a benzyl alcohol as a solvent, on the other hand, were weighed in a weight ratio of 2.5:1, and mixed together for 3 minutes in such a manner that no air bubbles got mixed in the mixture, followed by deaeration for 3 minutes. By doing so, an adhesive free from air bubbles was prepared.

The stress-luminescent particles (B) are ceramics anisotropic Sr_{0.9}Al₂O₄:Eu_{0.01} particles as shown in the above-described Example 1. Rod-shaped particles whose length in the longer direction was 2 □m on the average and whose length in the shorter direction was 0.3 □m on the average were used. As the stress-increasing structures (C), alumina particles available from Japan Pure Chemical Co., Ltd. were used. The average particle diameter of the alumina particles was 10 □m. 0.9 g of powder of the stress-luminescent particles (B) and 0.1 g of powder of the stress-increasing structures (C) were weighed and mixed together thoroughly. The resulting mixture was mixed with the epoxy adhesive (A) in a weight ratio of 1:1, thereby obtaining an adhesive containing a stress-luminescent material.

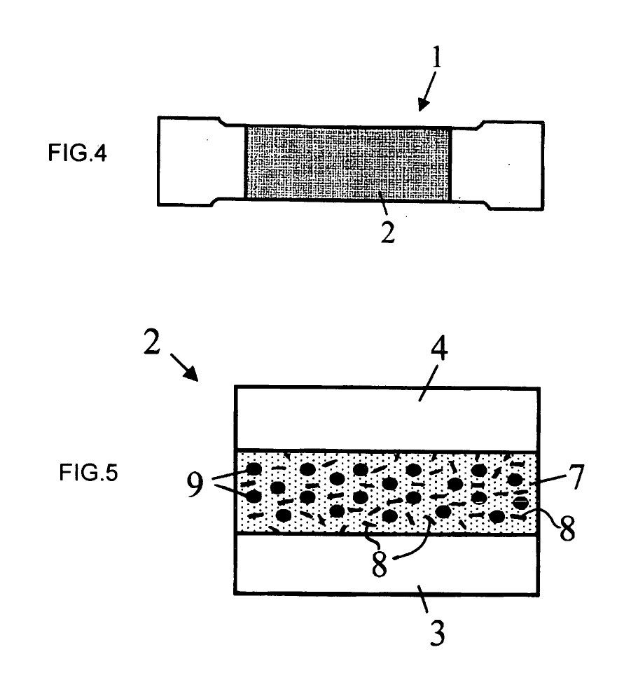

The outline of a test piece 1 is shown in FIGS. 4 and 5. The test piece 1 has an epoxy resin 3 and a transparent acrylic sheet 4 superimposed over each other and bonded together with the adhesive. FIG. 5 is an enlarged view of a superimposed portion 2 in FIG. 4 formed by bonding together the epoxy resin 3 and the transparent acrylic sheet 4 with the adhesive. In FIG. 5, reference numeral 7 denotes the adhesive. Reference numeral 8 denotes stress-luminescent particles, and reference numeral 9 denotes stress-increasing structures.

The adhesive containing the stress-luminescent material was applied to the surface of the epoxy resin 3 having a thickness of 1 mm, and the transparent acrylic sheet 4 (thickness: 0.3 mm) was superimposed over the epoxy resin 3 and secured with end spacers so that the thickness of the adhesive was 50 □m, thereby bonding the acrylic sheet 4 to the epoxy resin 3, followed by curing at 30° C. for 24 hours. The test piece 1 thus obtained was subjected to a tensile load of 100 N with a material testing machine available from TENSILON to observe luminescence.

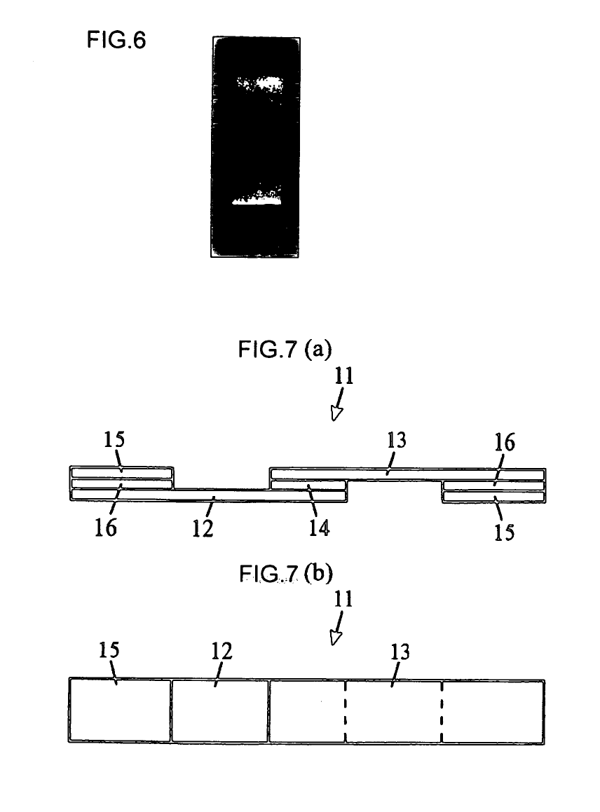

As the load applied from the material testing machine increased, the luminous intensity increased, and the luminescence was clearly observable with the naked eye. FIG. 6 is a photograph showing the emission of luminescence from the test piece. Strong luminescence was also observable when the test piece was bent by hand. Even when the testing was repeated, the adhesive layer of the stress-luminescent material on the epoxy resin test piece remained firmly bonded thereto. There was no separation of the adhesive layer at all until rupture of the epoxy resin.

### Second Embodiment

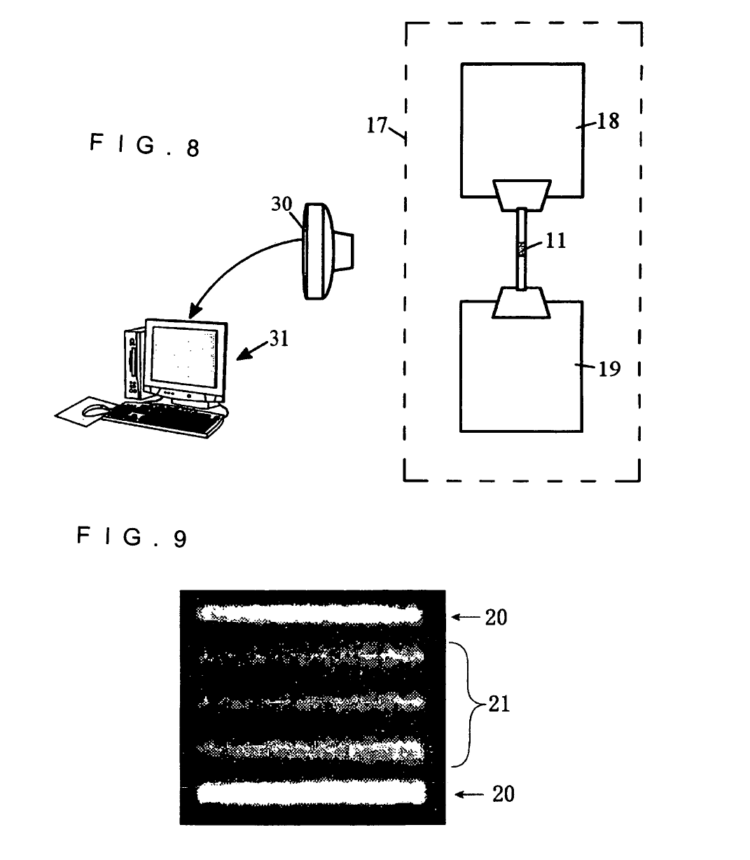

A second embodiment of the present invention will be outlined below. As an example of the second embodiment of the present invention, an example of an acrylic adhesive (see Example 3) will be explained below. FIG. 7 illustrates the outline of a test piece 11. Part (a) of FIG. 7 is a front view of the test piece 11. Part (b) of FIG. 7 is a plan view of the test piece 11. FIG. 8 illustrates the outline of a measuring apparatus. The test piece 11 has a first material 12 and a second material 13 as materials to be bonded to each other. The first material 12 and the second material 13 are bonded with an adhesive 14. The adhesive 14 has a stress-luminescent material powder mixed therein. The measuring apparatus comprises a stress applying device 17, a receiving device 30, and an analyzing device 31. The stress applying device 17 is for applying a mechanical stress to the test piece 11.

The mechanical stress applied to the test piece 11 is a tensile force pulling the test piece 11 from both ends thereof, or a pressure compressing the test piece 11 from both ends thereof. The stress applying device 17 may repeatedly apply a pulling force or a pressure to the test piece 11 at predetermined intervals of time. The stress-luminescent material converts the applied strain energy into light energy. Therefore, the amount of luminescence decreases with time if only a single stress is applied. With a view to facilitating measurement, it is desirable to apply repeated stress to maintain continuous luminescence during observation of the test piece 11.

The stress-luminescent material uses a composite metal oxide containing strontium and aluminum as a base material, which is doped with a rare earth metal or a transition metal as a luminescent center. Examples of desirable stress-luminescent materials are SrMgAl₁₀O₁₇:Eu, SrAl₆O₁₁:Eu, SrLaAl₃O₇:Eu, SrYAl₃O₇:Eu, and SrAl₂SiO₇:Eu. With a view to allowing recognition of luminescence with the naked eye, it is preferable for the stress-luminescent material to be formed from a base material doped with a rare earth metal or a transition metal that emits visible light. It is particularly preferable that the stress-luminescent material should be a ceramic powder material consisting essentially of a defect-controlled type europium-activated strontium aluminate (SrAl₂O₄:Eu). It is even more preferable to use anisotropic stress-luminescent material particles, which can increase the luminous intensity.

The receiving device 30 is for receiving a light wave emitted from the test piece 11. Examples of the receiving device 30 include imaging devices for imaging visible light, infrared rays, far-infrared rays, and ultraviolet rays, i.e. a CCD camera, and a high-speed video imaging system. The analyzing device 31 is for analyzing the light wave received by the receiving device 30 to obtain features of the received light wave, e.g. a distribution thereof. The analyzing device 31 may be any type of machine or device, provided that it can analyze the image or video image received or taken by the receiving device 30 and analyze the light wave emitted from the adhesive 14 to grasp the features thereof.

The stress-luminescent material is preferably formed by doping the following base material with a luminescent center consisting essentially of at least one rare earth or transition metal that emits luminescence when their electrons excited by mechanical energy return to their ground state.

The stress-luminescent material is prepared by using a composite metal oxide containing strontium and aluminum as a base material and doping it with a rare earth metal or a transition metal as a luminescent center. Examples of such a composite metal oxide are xSrO.yAl₂O₃.zMO (M is a divalent metal such as Mg, Ca, or Ba; x, y and z are integers), and xSrO.yAl₂O₃.zSiO₂ (x, y and z are integers). SrMgAl₁₀O₁₇:Eu, (SrₓBa₁₋ₓ)Al₂O₄:Eu (0<x<1), SrAl₂SiO₇:Eu, etc. are desirable materials. A particularly preferable stress-luminescent material is a ceramic powder material consisting essentially of a defect-controlled type europium-activated strontium aluminate (SrAl₂O₄:Eu)

(Operation of Measuring Apparatus)

The test piece 11 is secured at both ends with grippers 18 and 19 of the stress applying device 17, and stress is applied to the test piece 11 at a predetermined repeating cycle by the stress applying device 17. The external stress causes the stress-luminescent material contained in the adhesive 14 to emit luminescence. Thus, a light wave is emitted. The emitted light wave is received or taken by the receiving device 30. The image or video image received or taken by the receiving device 30 is analyzed by the analyzing device 31 to grasp the way in which the stress-luminescent material emits luminescence and to obtain the luminescence frequency, etc. The analysis reveals the way in which the adhesive 14 is distributed. Particularly, a crack in the adhesive 14 can be detected because no luminescence is emitted from a cracked portion of the adhesive 14. It is also possible to detect an end of a crack and to grasp the trend of crack propagation.

### EXAMPLE 3

Next, a specific example 3 of the test piece 11 and the measuring apparatus will be explained. The test piece 11 was a combination of two acrylic sheets bonded together with an adhesive, which was used as a simple overlap joint test piece. The adhesive had a stress-luminescent powder mixed therein. This arrangement allows measurement of luminescence inside the transparent acrylic sheets. As the stress-luminescent material, the anisotropic stress-luminescent material in Example 1 was used.

As the adhesive, a reactive acrylic adhesive MA310 (manufactured by ITW Industry Co., Ltd., Plexus Department) was used in view of bondability with the acrylic sheets. The adhesive was mixed with 20 wt % of stress-luminescent powder. The thickness of each acrylic sheet was 2 mm. The overlap length was 25 mm. The other dimensions were set in accordance with JIS K6850(2). In the bonding operation, the acrylic sheets were bonded to each other by using spacers so that the adhesive layer thickness was 1 mm.

As the stress applying device 17, a hydraulic 10-ton fatigue testing machine (manufactured by Instron Corporation) was used. As stress applied to the test piece 11, repeated stress with a displacement amplitude of +0.6 mm was applied at a loading cycle of 20 Hz by the stress applying device 17. The stress-luminescent material in the test piece 11 converts the applied strain energy into light energy. Therefore, the amount of luminescence decreases with time if only a single stress is applied. With a view to facilitating measurement, repeated stress was applied in this experiment to maintain continuous luminescence during measurement of the test piece.

As the receiving device 30, WAT-525EX (manufactured by WATEC, Co., Ltd.), which is a high-sensitivity CCD camera, was used. The way in which luminescence was emitted from the test piece 11 was imaged by the receiving device 30 and recorded on videotape. Thereafter, image analysis was carried out by a computer to perform acquisition of luminous intensity data, image enhancement and so forth. The experiment revealed that the bonded joint started to emit luminescence after the stress application had begun, and the luminescence was visible light clearly recognizable with the naked eye.

FIG. 9 shows an image of the bonded joint taken with the CCD camera. In the illustrated image, the vertical direction is the longitudinal direction of the test piece 11. There are lateral stripes 20 of high luminous intensity at the upper and lower end portions (bonded joint end portions). Accordingly, it is understood that there is a strong stress concentration at each end portion of the bonded joint. This fact supports the conventional theory. There are some lateral stripes 21 of low luminous intensity in the center of the bonded joint of the test piece 11. This is a result unexpected from static stress application. The lateral stripes 21 are deemed to be produced by vibrations due to the repeated stress application or interference between deflection waves.

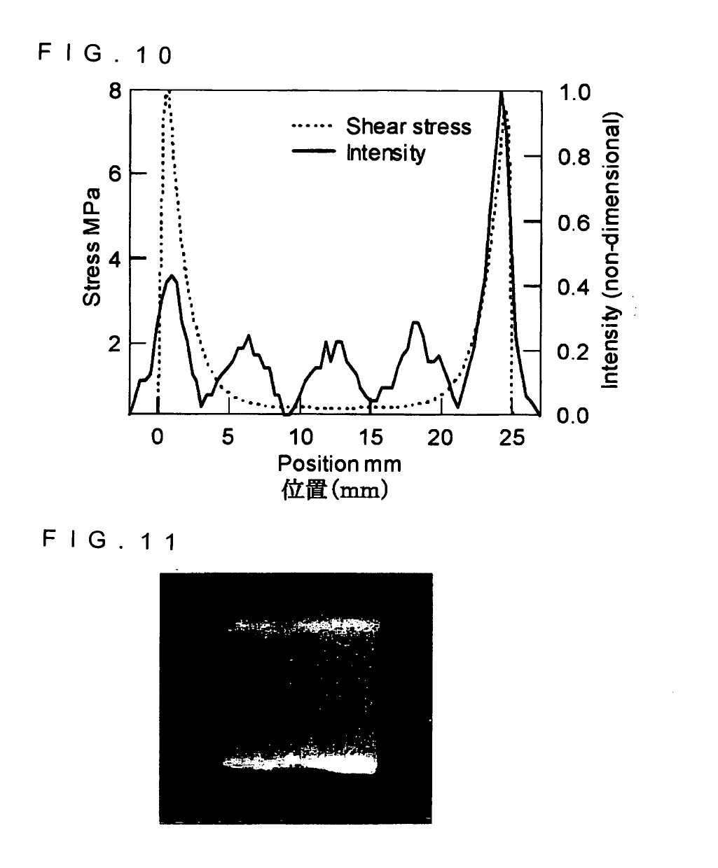

The graph of FIG. 10 shows the luminous intensity distribution in the longitudinal direction of the bonded joint of the test piece 11 and a stress distribution obtained by the finite element method. The abscissa axis of the graph represents the position of the bonded joint of the test piece 11 in units of millimeters. The ordinate axis of the graph represents the luminous intensity distribution and the stress distribution obtained by finite element method in a non-dimensional manner. The right-hand ordinate axis of the graph represents the luminous intensity in a non-dimensional manner. The luminous intensity distribution is shown by the solid line.

The left-hand ordinate axis of the graph shows the stress applied to the test piece 11, which was obtained by the finite element method. The stress distribution is shown by the dotted line. The luminous intensity distribution agrees well in tendency with the expected stress distribution, although there are some small peaks in the luminous intensity distribution that are supposed to be attributable to the effect of dynamic stress application. There are two high peaks at both ends of the solid line in FIG. 10. The high peaks are the lateral stripes 20 in FIG. 9. A plurality of low peaks in the middle of the solid line are the lateral stripes 21 in FIG. 9.

The test piece 11 was pulled slowly by the stress applying device 17 to measure a stress distribution in the adhesive layer. The way in which luminescence was emitted from inside the adhesive layer was imaged with the CCD camera. The luminescence emitted from the adhesive layer was recognizable with the naked eye. FIG. 11 is a photograph obtained when the test piece 11 was pulled slowly by the stress applying device 17. It will be understood that the luminous intensity is high at the upper and lower end portions of the photograph shown in FIG. 11.

### Third Embodiment

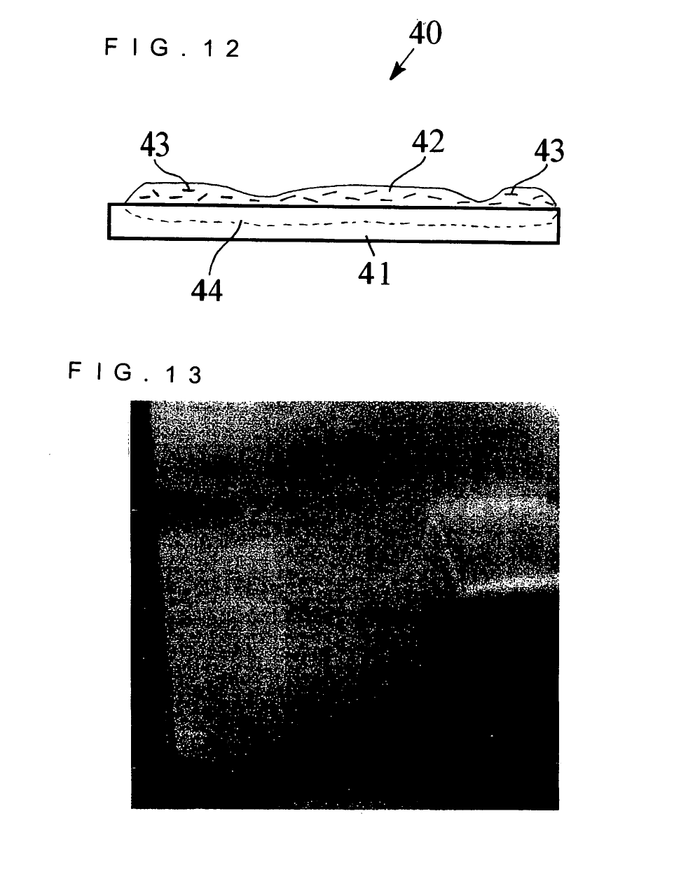

A third embodiment of the present invention will be outlined below. As an example of the third embodiment of the present invention, a sheet-shaped stress-luminescent structure 40 was prepared, as shown in FIG. 12, by applying a coating material mixed with a stress-luminescent material to a surface of paper. As illustrated in the figure, a coating material 42 mixed with a stress-luminescent material 43 is applied to a surface of paper 41. A part of the coating material 42 permeates into the paper 41 to form a permeation layer 44. Therefore, if the sheet-shaped stress-luminescent structure 40 is touched with a hand or a tool such as a pencil, the contacted portion is stressed, causing the stress-luminescent material 43 to emit luminescence.

### EXAMPLE 4

Example 4 carried out by mixing a stress-luminescent material into a coating material will be explained below. Specifically, a sheet-shaped stress-luminescent structure containing a powder of stress-luminescent material in Example 1 was prepared. The stress-luminescent material powder is anisotropic particles having an aspect ratio of not less than 2. The stress-luminescent material powder was homogeneously mixed with an ink for screen printing. The ink was a transparent, two-part urethane-based ink.

The diameter of the anisotropic stress-luminescent material particles mixed into the ink was 2 □m on the average. The ink mixed with the stress-luminescent material powder was screen-printed on paper for PPC having a thickness of 90 □m and a weighing of 64 g/m² so as to permeate into the paper, followed by drying at room temperature. The ink containing the stress-luminescent material powder was printed on a single side of the paper. The stress-luminescent material particles were elongate in shape and had an aspect ratio of not less than 2.

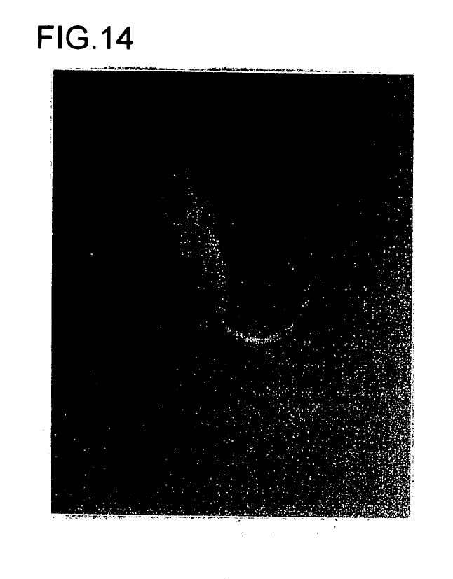

The ink was screen-printed on the paper so that a part of the ink permeated into the paper. The ink was dried and fixed. The ink containing the stress-luminescent material powder was uniformly or partially screen-printed on the paper. When the surface of the sheet-shaped stress-luminescent structure prepared as stated above was touched, luminescence was emitted from the touched position, leaving trails of light as shown in FIGS. 13 and 14. Particularly, FIG. 14 clearly shows a trail of light when the letter “O” was drawn.

It was confirmed that when the sheet-shaped stress-luminescent structure was folded or unfolded, the folded edge portion emitted luminescence more strongly than the other portions. The ink containing the stress-luminescent material powder can be printed in a predetermined pattern.

The composition according to the present invention may contain other additives. Preferable examples of other additives are a fire retardant, a heat stabilizer, an antioxidant, an anti-ultraviolet agent, a plasticizer, a crystal nucleus agent, a blowing agent, an anti-fungus agent, a filler, a reinforcing agent, an electrically conducting filler, and an antistatic additive.

The present invention is not necessarily limited to the foregoing first to third embodiments. Embodiments obtained by modifying the above-described embodiments in a variety of ways or by combining together appropriate technical means within the scope of the appended claims fall within the technical scope of the present invention. The above-described adhesives can be used as coating materials.

The stress-luminescent material according to the present invention emits luminescence by converting a mechanical vibration or load into light energy. Therefore, the present invention is preferably used for the purpose of detecting a spot that transmits a mechanical vibration, or monitoring a mechanical vibration generating source. As industrial use applications, it is preferable to use the present invention in systems for detecting vibration, collapse or destruction of structures such as plants, buildings, and tunnels, thereby utilizing the present invention for safety control and disaster diagnosis of these buildings.

The present invention can be adapted to systems for remotely monitoring the above-described buildings. The present invention is preferably used as a passive sensor. Further, the present invention allows rapid inspection and safety control of the buildings and hence offers an extended lifetime. It is also preferable to use the present invention as a non-contact optical stress sensor that does not need electrodes, wiring, etc. for various stress measurements that cannot be performed by conventional stress sensors.

As consumer products, the present invention is applicable to nighttime crime prevention goods and visible safety goods, e.g. garments such as shoes and sportswear, tires of wheels of cars, bicycles, etc., and road signs. The present invention is also applicable to amusement items, e.g. toys and event goods, and key buttons that become luminous when touched with a hand at nighttime. It is expected that the present invention will create new use applications in various fields by being integrated with a wide range of materials, such as metals, resins, rubber, and fibers, and will be developed therein.

1. A stress-luminescent material that emits luminescence when external mechanical energy is applied thereto, said stress-luminescent material comprising:
stress-luminescent fine particles which consists essentially of an inorganic base material doped with at least one of rare earth and transition metals that emit luminescence when their electrons excited by said mechanical energy return to their ground state, said at least one of rare earth and transition metals serving as a luminescent center, and
said stress-luminescent fine particles having an anisotropic aspect ratio.

2. A stress-luminescent material according to claim 1, wherein said stress-luminescent fine particles have at least one external shape selected from the group consisting of an angular shape, a plate shape, an acicular shape, and a rod shape.

3. A stress-luminescent material according to claim 2, wherein at least either of said rod-shaped and acicular stress-luminescent fine particles have an aspect ratio of from 2 to 1000.

4. A stress-luminescent material according to claim 3, wherein said stress-luminescent fine particles change luminous intensity in proportion to change in magnitude of energy applied thereto.

5. A stress-luminescent material according to claim 1, which is at least one of an aluminate and a silicate.

6. A bonding agent for bonding together a first material and a second material that are materials to be bonded, said bonding agent containing said stress-luminescent material according to claim 1.

7. A bonding agent according to claim 6, which is a composite adhesive comprising at least one adhesive selected from the group consisting of a thermosetting resin adhesive, a thermoplastic resin adhesive, and a rubber adhesive.

8. A bonding agent according to claim 6, which contains microstructures for increasing stress, said microstructures having a higher modulus of elasticity than that of said bonding agent.

9. A bonding agent according to claim 8, wherein said microstructures are fine particles of at least one material selected from the group consisting of metals, glass, ceramics, plastics, synthetic fiber, and natural fiber.

10. A bonding agent according to claim 9, wherein said microstructures are fine particles having at least one shape selected from the group consisting of fibrous, acicular and spherical shapes.

11. A bonding agent according to claim 6, which is transparent and flexible.

12. A stress-luminescent composition containing said stress-luminescent material according to claim 1, and at least one additive selected from the group consisting of a coating material, an ink, a fire retardant, a heat stabilizer, an antioxidant, an anti-ultraviolet agent, a plasticizer, a crystal nucleus agent, a blowing agent, an anti-fungus agent, a filler, a reinforcing agent, an electrically conducting filler, and an antistatic additive.

13. A coating material dispersedly containing said stress-luminescent material according to claim 1.

14. An ink dispersedly containing said stress-luminescent material according to claim 1.

15. A stress-luminescent sheet comprising a sheet-shaped material impregnated at either of a surface and inside thereof with said stress-luminescent material according to claim 1.

16. A stress-luminescent sheet comprising a sheet-shaped material impregnated at either of a surface and inside thereof with said bonding agent according to claim 6.

17. A stress-luminescent sheet comprising a sheet-shaped material impregnated at either of a surface and inside thereof with said stress-luminescent composition according to claim 12.

18. A method of producing a stress-luminescent material that emits luminescence when external mechanical energy is applied thereto, said stress-luminescent material consisting essentially of an inorganic base material doped with at least one of rare earth and transition metals that emit luminescence when their electrons excited by said mechanical energy return to their ground state, said at least one of rare earth and transition metals serving as a luminescent center, and said stress-luminescent material comprising stress-luminescent fine particles having an anisotropic aspect ratio, said method comprising:
mixing together an acid salt of said at least one of rare earth and transition metals and a raw material of said inorganic base material in a solvent while adding aqueous ammonia thereto so that a predetermined pH value is obtained, thereby forming a sol-gel solution; and
adding and mixing a dispersing and emulsifying agent into said sol-gel solution and drying a resulting mixture, followed by heat-treating;
wherein said aspect ratio is controlled by changing said pH value.
